(19) United States
(12) Patent Application Publication
(10) Pub. No.: US 2023/0290258 A1
(43) Pub. Date: Sep. 14, 2023

(54) SOLE SENSOR SYSTEM

(71) Applicant: Charles Isgar, Scottsdale, AZ (US)

(72) Inventor: Charles Isgar, Scottsdale, AZ (US)

(21) Appl. No.: 18/319,880

(22) Filed: May 18, 2023

Related U.S. Application Data
(63) Continuation-in-part of application No. 17/201,919, filed on Mar. 15, 2021.
(60) Provisional application No. 63/084,228, filed on Sep. 28, 2020.

(51) Int. Cl. G09B 5/02; G01L 5/22; G01L 5/16; A43B 17/00; A43B 3/44

(52) U.S. Cl. CPC G09B 5/02; G01L 5/225; G01L 5/16; A43B 17/00; A43B 3/44; G09B 19/167

(57) ABSTRACT

A sole sensor system is provided. The sole sensor system that includes a sensor or sensors within insoles for use with footwear, wherein the sensors wirelessly send sensor data to a user computing device that communicates with a server to process the sensor data to determine pressure points of the user's feet during various activities of the user.

### CROSS REFERENCE TO RELATED APPLICATION

This application is a continuation-in-part of U.S. patent application entitled “SOLE SENSOR SYSTEM,” Ser. No. 17/201,919, filed Mar. 15, 2021, which claims priority to U.S. Provisional patent application entitled “SOLE SENSOR SYSTEM,” Ser. No. 63/084,228, filed Sep. 28, 2020, the disclosure of which is hereby incorporated entirely herein by reference.

### BACKGROUND OF THE INVENTION

### Technical Field

This invention relates generally to a sensor system, and more particularly to a sole sensor system for collecting and reporting data regarding pressure a user's feet exert during various activities.

### State of the Art

In a given day, people spend varying amounts of time on their feet. The force exerted by the human body on the feet is not readily tracked during activity that individuals engage in. For example, it is not readily available to one to runs, walks, golfs, engages in other sports, drives or other daily labors or recreation. Because such data is not readily available, there is not a system that allows for a user to gather such information and then utilize the pressure data by the user to adjust such activities, provide certain cushion for the feet or for other purposes.

Accordingly, there is a need for a sole sensor system for collecting and reporting data regarding pressure a user's feet exert during various activities.

### DISCLOSURE OF THE INVENTION

The present invention relates to a sole sensor system that includes a sensor or sensors within insoles for use with footwear, wherein the sensors wirelessly send sensor data to a user computing device that communicates with a server to process the sensor data to determine pressure points of the user's feet during various activities of the user.

An embodiment includes a sole sensor system comprising: a computer server having a memory storing user data; a user computing device coupled to the computer server; and at least one sensor located in a sole of footwear worn by a user, the at least one sensor coupled to the user computing device, wherein the user computing device is programmed to: receive from the at least one sensor a signal that comprises sensor data collected as the user exerts force on the at least one sensor located in the sole of the footwear worn by the user; and automatically send the sensor data with user identification information to the computer server, wherein the computer server is programmed to: receive the sensor data and the user identification information from the user computing device and aggregate the sensor data as part of the user data associated with the user identification information received; and automatically generate and send for display on the user computing device pressure data based on the sensor data received, the pressure data comprising amount of pressure of at least one portion of a foot exerting force on the at least one sensor located in the sole of the footwear worn by the user.

The sole may be an insole. The insole may be deformable. The insole may be formable to correspond foot shape of the user. The insole may be coupled within the footwear. The at least one sensor may be a plurality of sensors. The pressure data may comprise the force to the footwear that is applied to a gas pedal or a brake pedal. The sensor data may comprise location information. The sensor data may be reported continuously. The sensor data mat be reported at predetermined time intervals. The identification information may comprise a name. The footwear may be ski boots. The pressure data may show how the user adjusts weight when skiing downhill. The footwear may be golf shoes. The pressure data may show how the user adjusts weight when swinging a golf club. The footwear may be skateboard shoes The pressure data may show how the user adjusts weight to balance. The footwear may be wake board shoes. The pressure data may show how the user adjusts weight to balance.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a diagrammatic view of a sole sensor system in accordance with an embodiment;

FIG. 2 is a view of insoles for footwear with sensors located therein in accordance with an embodiment;

FIG. 3 is a perspective view of feet engaging insoles for footwear with sensors located therein in accordance with an embodiment;

FIG. 4 is a perspective view of a user walking with shoes having insoles with sensors located in the shoes in accordance with an embodiment;

FIG. 5 is a view of a user computing device showing tracking of step locations of a user operating the sole sensor system in accordance with an embodiment; and

FIG. 6 is a perspective view of a user depressing a gas pedal with shoes having insoles with sensors located in the shoes in accordance with an embodiment.

### DETAILED DESCRIPTION OF EMBODIMENTS OF THE INVENTION

As discussed above, embodiments of the present invention relate to a sole sensor system that includes a sensor or sensors within insoles for use with footwear, wherein the sensors wirelessly send sensor data to a user computing device that communicates with a server to process the sensor data to determine pressure points of the user's feet during various activities of the user.

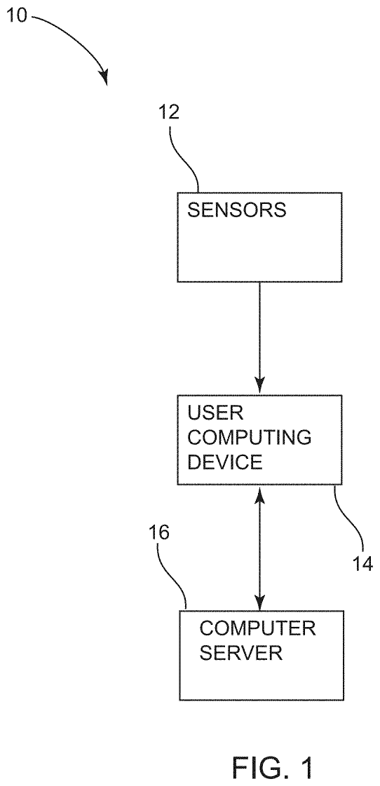

Referring to the drawings, FIG. 1 depicts an embodiment of a sole sensor system 10. The system 10 may include at least one sensor 12, a user computing device 14, and a computer server 16, wherein the user computing device 14 is coupled to the computer server 16. This coupling may be a network connection, such as through an Internet connection, wherein the user computing device 14 may communicate with and receive communication from the server 16. Additionally, the sensor 12 is coupled to the user computing device 14 and operates to communicate sensor data to the user computing device 14.

The computer server 16 may include a memory storing user data. The user data may include identification information, such as a name and so forth. A sensor 12 may be located in a sole of footwear worn by a user. The sensor 12 may be coupled to the user computing device 14 and the user computing device 14 may be coupled to the computer server 16. The user computing device is programmed to receive from the at least one sensor a signal that the includes sensor data collected as the user exerts force on the at least one sensor located in the sole of the footwear worn by the user; and automatically send the sensor data with user identification information to the computer server. The computer server may be programmed to receive the sensor data and the user identification information from the user computing device and aggregate the sensor data as part of the user data associated with the user identification information received; and automatically generate and send for display on the user computing device pressure data based on the sensor data received, the pressure data including amount of pressure of at least one portion of a foot exerting force on the at least one sensor located in the sole of the footwear worn by the user.

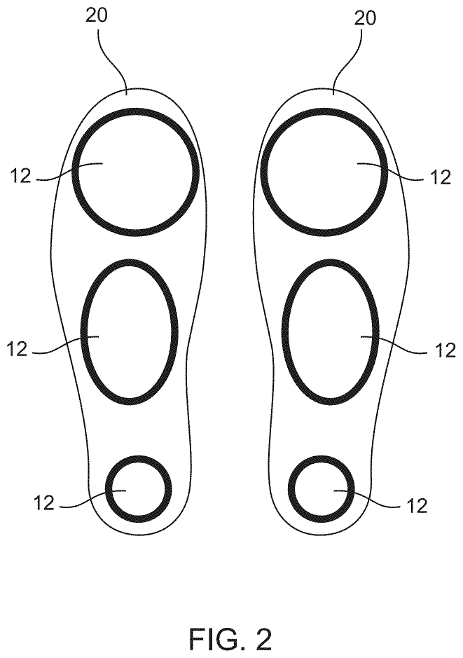

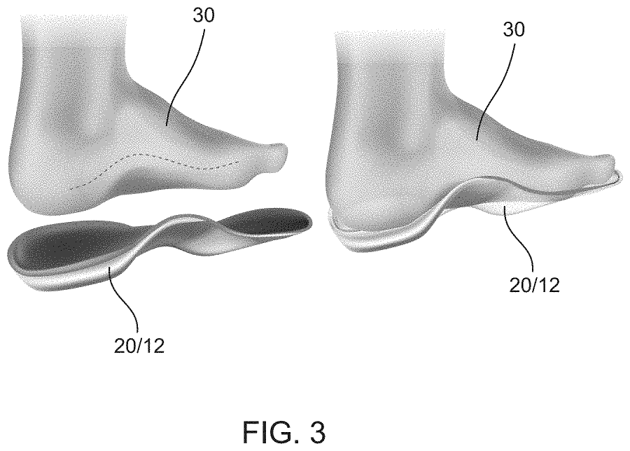

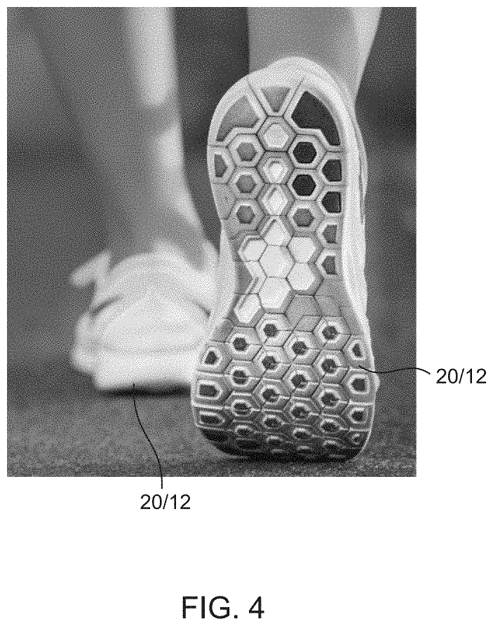

Referring to FIG. 2, insoles 20 for footwear may include sensors 12. In some embodiments, it may be one sensor 12 and in others, there may be a plurality of sensors 12 coupled within the insoles 20. The sensors 12 may be located in any location within the insoles 20 that may provide the useable data. As further depicted in FIGS. 3 and 4, a user's foot 30 may engage the insoles 20. As such, the insoles may be deformable or formable to correspond to the user's foot shape. The insoles 20 may be insoles that may be coupled within footwear or shoes worn by the user. As the user walks and moves about his or her day, the sensors 12 may continually communicate with the user computing device 14. This may be a continual reporting, each time the sensors receive pressure, at certain time intervals or the like.

The sensor(s) 12 may operate to determine what part of the foot is bearing the weight, the rolling and function of a foot and shoe, the time spent standing and walking, what muscles are doing the most work, exercise feedback, workplace monitoring for time on feet, shoe fitting, golf balance and so forth. While the figures depict that the sensors 12 are located in the insoles, it is contemplated that the sensors may be located in the soles of the shoes.

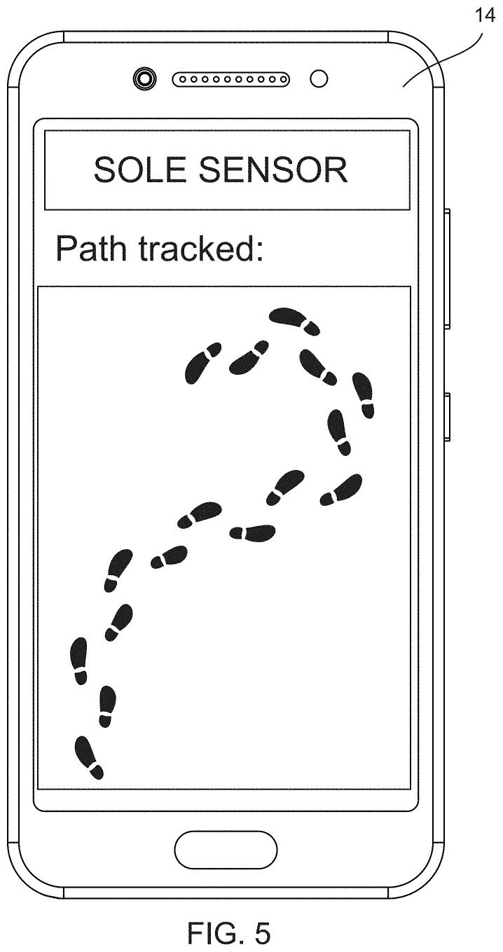

Further still, the system 10 may operate to provide additional data aside from pressure data from the sensors 12. The sensors 12 may also provide location information either from the sensors 12 themselves or from the user computing device 14 that the sensors are connected to. The system 10 may include the user computing device 14 operating to depict a path of travel or the steps taken by the user as shown in FIG. 5. This path may be collected and aggregated in the server and then utilized by the user at different times for user purposes. In these embodiments, the server may be programmed to automatically compare the sensor data collected by the sensors and compare with the collected and aggregated sensor data and provide a recommendation to the user computing device on changes or adjustments the user can make to recreate the pressure sensor data that was previously collected that had a desired outcome during an activity. This activity may be a sport like golf, skiing, wakeboarding, running and the like. This may also be utilized to track social interactions and identify where individuals move and show how those movements occur.

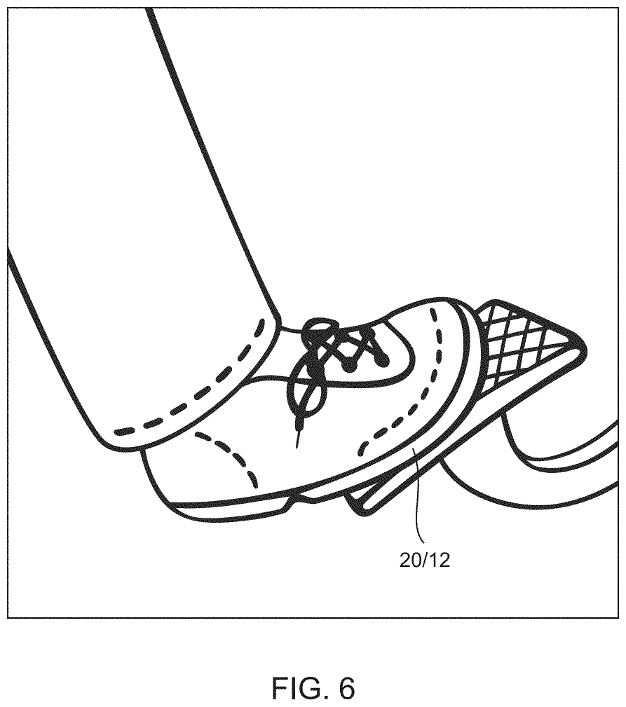

Additionally, the sensors 12 in the insoles 20 or in shoes may be used for other purposes. For example, the sensors 12 in the insoles or shoes may be used to track pressure in other situations. FIG. 6 includes one such instance wherein the sensors 12 report the force to the shoe that is applied to the gas pedal or the brake pedal. This information can be reported to the server 16 and then utilized to assist in the driving habits of the user and may also be used for insurance purposes.

There are many other shoe types that such a system may be utilized. For example, ski boots to see how the user adjusts weight when skiing down hill and the data utilized to improve the skiing ability, time down the hill or the like. It may be in golf shoes to see how the weight is on various shots and golf swings and how the weight/force on feet adjusts as the round of golf proceeds. Use in skateboard shoes, wake board bindings (shoes), and other sports where balance may be critical. The data provides information to assist the user in various ways.

Embodiments may be available on or through the internet, such as through domain names reserved and owned by Applicant that include data-sole.com, myshoedata.com, shoeanalytics.com, step-data.com, stepupdata.com, ai-shoe.com or the like.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A sole sensor system comprising:
a computer server having a memory storing user data;
a user computing device coupled to the computer server; and
at least one sensor located in a sole of footwear worn by a user, the at least one sensor coupled to the user computing device, wherein the user computing device is programmed to:
receive from the at least one sensor a signal that comprises sensor data collected as the user exerts force on the at least one sensor located in the sole of the footwear worn by the user during an activity; and
automatically send the sensor data with user identification information to the computer server, wherein the computer server is programmed to:
receive the sensor data and the user identification information from the user computing device and aggregate the sensor data as part of the user data associated with the user identification information received;
automatically generate and send for display on the user computing device pressure data based on the sensor data received, the pressure data comprising amount of pressure of at least one portion of a foot exerting force on the at least one sensor located in the sole of the footwear worn by the user; and
automatically generate and send for display on the user computing device recommendations to adjustments by the user based on a comparison of the sensor data received compared with the aggregated sensor data.

2. The sole sensor system of claim 1, wherein the sole is an insole.

3. The sole sensor system of claim 2, wherein the insole is deformable.

4. The sole sensor system of claim 2, wherein the insole is formable to correspond foot shape of the user.

5. The sole sensor system of claim 2, wherein the insole is coupled within the footwear.

6. The sole sensor system of claim 1, wherein the at least one sensor comprises a plurality of sensors.

7. The sole sensor system of claim 1, wherein the pressure data comprises the force to the footwear that is applied to a gas pedal or a brake pedal.

8. The sole sensor system of claim 1, wherein the sensor data comprises location information.

9. The sole sensor of claim 1, wherein the sensor data is reported continuously.

10. The sole sensor system of claim 1, wherein the sensor data is reported at predetermined time intervals.

11. The sole sensor system of claim 1, wherein the identification information comprises a name.

12. The sole sensor system of claim 1, wherein the footwear is ski boots.

13. The sole sensor system of claim 12, wherein the pressure data shows how the user adjusts weight when skiing downhill.

14. The sole sensor system of claim 1, wherein the footwear is golf shoes.

15. The sole sensor system of claim 14, wherein the pressure data shows how the user adjusts weight when swinging a golf club.

16. The sole sensor system of claim 1, wherein the footwear is skateboard shoes.

17. The sole sensor system of claim 16, wherein the pressure data shows how the user adjusts weight to balance.

18. The sole sensor system of claim 1, wherein the footwear is wake board shoes.

19. The sole sensor system of claim 18, wherein the pressure data shows how the user adjusts weight to balance.
